(19) United States
(12) Patent Application Publication
(10) Pub. No.: US 2010/0312723 A1
(43) Pub. Date: Dec. 9, 2010

(54) PAINT HARDENING COMPOSITIONS AND ENVIRONMENTALLY CONSCIOUS METHODS FOR RECYCLING PAINT AND PAINT CONTAINERS

(75) Inventors: Aimee Lawlor, Strongsville, OH (US); Maria French, Strongsville, OH (US)

Correspondence Address: AKZO NOBEL INC., LEGAL & IP, 120 WHITE PLAINS ROAD, SUITE 300, TARRYTOWN, NY, 10591, US

(73) Assignee: Akzo Nobel Coatings International B.V., Arnhem (NL)

(21) Appl. No.: 12/795,902

(22) Filed: Jun. 8, 2010

Related U.S. Application Data
(60) Provisional application No. 61/185,378, filed on Jun. 9, 2009.

(30) Foreign Application Priority Data
Jul. 9, 2009 (EP) 09165041.6

(51) Int. Cl. G06Q 90/00; C09D 7/12

(52) U.S. Cl. 705/500; 524/557; 106/316

(57) ABSTRACT

The present invention relates to environmentally conscious methods for the distribution and collection of recyclable paint containers, methods for environmentally conscious painting using recyclable paint and paint containers, and compositions for hardening paint for purposes of recycling paint and paint containers. A consumer can employ a paint hardener to harden unused paint, dispose the hardened paint at curbside, and return the empty paint container to a collection area at a business establishment. The paint hardened can be contained in an encapsulating layer which dissolves and releases the paint hardener into the paint. The business establishment can recycle the empty paint container into a new paint container.

### BACKGROUND OF THE INVENTION

1. Field of the Invention

The present invention relates to environmentally conscious methods for the distribution and collection of recyclable paint containers, methods for environmentally conscious painting using recyclable paint and paint containers, and compositions for hardening paint for purposes of recycling paint and paint containers.

2. Description of Related Art

In many municipalities, it is illegal to dispose paint, paint containers and other coating compositions and containers at curbside with household trash. In attempts to prevent unauthorized disposal, many municipalities have established designated collection areas and curbside collection days for discarding such materials. Moreover, some paint manufacturers have been required to collect used paint and paint containers to ensure acceptable disposal. However, it is nonetheless common for consumers to pour unused paint in the drain and even store partially empty paint containers in the garage or basement for long periods of time. It has therefore been desired to provide a convenient way for consumers to discard such coating compositions and their containers in an environmentally conscious manner.

WO 2009/006678 discloses a chemical agent for coagulating paint. The coagulated paint is removed from the paint container and buried in the ground, disposed at the dump, or disposed with general household waste. WO '678 explains that the empty paint containers can be recycled after the paint has been coagulated and removed.

WO 97/05035 discloses a reusable container for containing substances such as paint. A paint manufacturer collects the used container having residual material, separates the material from the container, and recycles the container.

WO 2008/010621 discloses a method for recycling waste paint containers, where the containers are crushed and the residual paint is removed from the crushed containers using an organic solvent.

DE 4140420 and DE 4209015 disclose methods for recycling plastic paint containers where the residual paint is separated from the containers in a grinding process.

US 2007/0266901 and US 2008/0148995 disclose compositions for tinting paint where a tinting material is contained within a dispersible encapsulating pouch which releases the tinting material into the paint.

### SUMMARY OF THE INVENTION

The present invention provides environmentally conscious and convenient methods for consumers, contractors and the like to dispose and recycle paint and paint containers by involving business establishments that sell, for non-limiting example, paint and paint related products (hereinafter, the term “consumer” includes consumers, contractors, and other persons who purchase or apply paint and paint related products). The paint may be a low or no VOC paint. Although the current disclosure and claims may refer to paint and paint containers as exemplary embodiments, it is to be understood that the present invention includes any container and its contents. For non-limiting example, the present invention includes paint, stain, varnish and other types of coating compositions and their containers and is applicable to them.

The term “business establishment” includes manufacturers, distributers, retailers, hardware stores and independent dealers which provide paint and paint related products. The business establishments participate in the paint container disposal and recycling process by providing locations where consumers can return used paint containers that no longer contain appreciable amounts of paint. The used paint containers can be recycled into new containers or can be used for other purposes.

The present invention includes methods for the distribution and collection of paint containers at a business establishment. In some embodiments of the invention, the method comprises the steps of selling paint and the paint container to a consumer at the business establishment, and collecting the paint container from the consumer at the business establishment, wherein the consumer has removed a portion of the left over paint from the paint container. In some embodiments, the method further comprises the step of selling a paint hardener to the consumer at a business establishment, which may or may not be the same business establishment where the consumer purchased the paint and paint container. The paint hardener may be provided to the consumer at no charge upon purchase of the paint. In some embodiments, the consumer employs the paint hardener to harden and remove the paint from the paint container and dispose the hardened paint with household waste. In some embodiments, the business establishment includes a bin or drop box for collecting the paint container from the consumer.

The present invention also includes methods for environmentally conscious painting comprising the steps of purchasing paint and a paint container from a business establishment, purchasing a paint hardener from a business establishment, painting a surface with the paint, adding the paint hardener to the unused paint to substantially harden the paint, removing the substantially hardened paint from the paint container, disposing the substantially hardened paint with household waste, and returning the paint container to a business establishment. The consumer may purchase the paint container, purchase the paint hardener, and return the paint container at the same or a different business establishment. In some embodiments, the business establishment includes a bin or drop box for collecting the paint container from the consumer.

The present invention further includes compositions for hardening paint for purposes of recycling paint and paint containers comprising a hardening compound which hardens the paint with mixing, and an encapsulating layer comprising at least one polymeric material which surrounds the hardening compound and dissolves in the paint with mixing. In some embodiments, a consumer purchases a paint and the paint hardener from a business establishment, employs the paint hardener to harden unused paint, removes the hardened paint from the paint container, disposes the hardened paint with household waste, and returns the paint container to a business establishment. The consumer may purchase the paint container, purchase the paint hardener, and return the paint container at the same or a different business establishment. In some embodiments, the business establishment includes a bin or drop box for collecting the paint container from the consumer.

### DETAILED DESCRIPTION OF THE INVENTION

As used in the afore-discussed embodiments and other embodiments of the disclosure and claims described herein, the following terms generally have the meaning as indicated, but these meanings are not meant to limit the scope of the invention if the benefit of the invention is achieved by inferring a broader meaning to the following terms.

Other than in the operating examples, or where otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements. Unless stated otherwise, all percentages, ratios and proportions herein are by weight and particularly unless otherwise specifically stated, the proportions of the components in the compositions described are given in percentage pertaining to the total mass of the mixture of these components.

Also herein, the recitations of numerical ranges by endpoints include all numbers subsumed within that range (e.g., 1 to 5 includes 1, 1.5, 2, 2.75, 3, 3.80, 4, 5, etc.).

Also herein, “a,” “an,” “the”, “at least one”, and “one or more” are used interchangeably.

Also herein, the term “comprises” and variations thereof do not have a limiting meaning where these terms appear in the description and claims.

The terms “for example”, “without limitation” and the like, as well as the exemplary compounds, ranges, parameters and the like disclosed throughout the application and claims are intended to identify embodiments of the invention in a non-limiting manner. Other compounds, ranges, parameters and the like can be employed by those skilled in the art without departing from the spirit and scope of the invention.

The present invention includes methods for the distribution and collection of a paint container at a business establishment, wherein a consumer has removed a portion of the paint from the paint container. For non-limiting example, the paint can be removed from the paint container by painting a surface in the consumer's home. Non-limiting examples of business establishments include manufacturers, distributers, retailers, hardware stores, independent dealers and other locations where paint and paint related products are sold. In some embodiments, a single business establishment distributes and collects the paint container. For non-limiting example, the paint container may be distributed and collected by a paint retailer. In some embodiments, the paint container is distributed and collected by different business establishments. For non-limiting example, a first business establishment such as a manufacturer may distribute the paint container and a second business establishment such as a retailer may collect the paint container. Also, for non-limiting example, a retailer at a first location may distribute the paint container and a retailer at a second location may collect the paint container.

In some embodiments of the invention, the paint is removed from the paint container using a paint hardener. Commercially available paint hardeners, such as the Waste Away Paint Hardener available from Homax Products, Inc., can be employed for this purpose. However, depending on the composition of the paint, it may be necessary to select a specific paint hardener which is capable of suitably hardening the paint such that it can be removed from the paint container by hand or with a tool. The selected paint hardener should substantially harden the paint such that no liquid paint remains in the container or a minimal amount of liquid paint remains in the paint container. A paint container that is substantially free of paint can therefore be collected at the business establishment. Moreover, the hardened paint can be disposed at curbside with household waste since it is less likely to leach if deposited in a landfill. A two-part system for environmentally responsible disposal of paint and paint containers is therefore provided wherein hardened paint is disposed, at curbside for example, and a substantially empty paint container is collected at a business establishment, possibly for recycling into a new paint container.

In some embodiments, the paint hardener is provided in a single packaging with an amount effective to harden approximately 10-25% of a gallon of the paint, which is a typical amount of left over paint in a paint container. The packaging may provide information which indicates the amount of paint hardener which should be employed to harden a certain volume of paint. By providing a premeasured amount of paint hardener specific for a discrete quantity of paint, consumers may be less likely to employ an incorrect amount of paint hardener. Paint hardener is therefore less likely to be wasted or over purchased, and a more efficient hardening system is achieved compared to paint hardeners sold in bulk volumes to harden approximately three gallons of paint.

In some embodiments of the invention, the paint hardener comprises a hardening compound which hardens the paint with mixing, and an encapsulating layer comprising at least one polymeric material which surrounds the hardening compound and dissolves in the paint with mixing. The encapsulating layer helps prevent spillage and/or improper handling of the liquid or solid paint hardener which facilitates controlled delivery into the paint container. Since some hardening compounds are hygroscopic, the encapsulating layer may extend the shelf life of the hardening compound by inhibiting moisture from contacting the hardening compound. Moreover, the shelf life of the paint hardener can be extended further by storing the paint hardener in a foil or other type of moisture resistant packaging which minimizes deterioration of moisture sensitive encapsulating layers. Non-limiting examples of encapsulating layers for surrounding the hardening compound can be found in US 2007/0266901 and US 2008/0148995, the contents of which are incorporated herein by reference. In some embodiments of the invention, the paint hardener is obtained from Orica Australia Pty Ltd. under Product Code—T7576/1 and the paint is The Freshaire Choicer™ obtained from Akzo Nobel Paints LLC. During the paint hardener manufacturing process, one or more paint hardening compounds are provided within the encapsulating layer to form a sealed pouch which contains the paint hardening compounds. The paint hardener including the sealed pouch containing the paint hardening compound is added to paint whereupon the encapsulating layer dissolves and releases the paint hardening compound. Stirring or mixing may be needed to dissolve the encapsulating layer and disperse the hardening compound so that the paint is hardened.

As disclosed in US '901 and US '995, the encapsulating layer in some embodiments of the present invention has a thickness of about 0.5 to about 5 mm, and includes from about 50% to about 100% of at least one water soluble polymer and about 0% to about 50% of a solvent. In some embodiments, the water soluble polymer comprises polyvinyl alcohol, pullulan, starch, hydroxyalkylated starch, or a mixture thereof. However, the composition and physical properties of the encapsulating layer may be varied as known by those skilled in the art. For non-limiting example, a polyethylene oxide encapsulating layer may be employed as disclosed in U.S. Pat. No. 3,294,224, or any other composition, such as starch, may be employed as disclosed in US '901 and US '995.

In some embodiments, a consumer purchases a paint and the paint hardener from a business establishment, employs the paint hardener to harden unused paint, removes the hardened paint from the paint container, disposes the hardened paint, and returns the paint container to a business establishment. The paint hardener may be provided to the consumer at no charge upon purchase of the paint, for non-limiting example, in a kit which includes paint and the paint hardener. The business establishment where the consumer purchases the paint hardener may be the same or a different business establishment which sells and collects the paint container. For non-limiting example, the paint container may be sold to a consumer at a first business establishment such as a hardware store, the paint hardener may be sold to a consumer at a second business establishment such as an independent paint dealer, and the paint container may be collected by a third business establishment such as a manufacturer. Similarly, the paint container may be sold, the paint hardener may be sold, and the paint container may be collected by a single type of business establishment in different locations, such as for non-limiting example, a hardware store in first, second and third locations.

In some embodiments of the invention, the business establishment includes a bin or drop box for collecting and recycling the paint container into a new paint container. This aspect of the invention helps provide a recycling program that minimizes disposal of metal, plastic and other types of paint containers at curbside for transportation to a landfill. The bin or drop box can promote environmental responsibility by including instructions or other information which recommends that paint containers should be returned and collected after the paint is substantially removed. The bin or drop box can include information which explains that the paint container will be recycled into a new paint container thereby providing an incentive to consumers to remove the hardened paint from the paint container and return the empty container for reuse and/or recycling of the container material. In some embodiments, the business establishment provides a coupon on the bin or drop box or in another location which entitles the consumer to a product rebate when purchasing or returning a paint container.

The business establishment may recycle the paint container into a new paint container or use the paint container for a different purpose. In some embodiments of the invention, the business establishment grinds the paint container into pellets or shreds the paint container and employs the pellets or shredded container to form a new paint container or other product. In some embodiments, the business establishment also cleans the paint container or pellets with a solvent or other compound that removes any residual paint or other materials.

The present invention includes methods and compositions which contribute to environmentally responsible painting. Paint and a paint hardener can be purchased from a business establishment, the hardened unused paint can be disposed at curbside, and the empty paint container can be returned to a business establishment. Consumers can therefore feel confident that their purchase of products which are recyclable in accordance with the present invention will contribute to environmental sustainability.

What is claimed is:

1. A method for the distribution and collection of a paint container comprising:
a) selling a paint and the paint container to a consumer at a first business establishment;
b) collecting the paint container from the consumer at the first business establishment or at a second business establishment, wherein the consumer has removed the paint from the paint container.

2. The method of claim 1, further comprising selling a paint hardener to the consumer at the first business establishment, at the second business establishment, or at a third business establishment.

3. The method of claim 2, wherein the consumer employs the paint hardener to harden and remove the paint from the paint container.

4. The method of claim 1, wherein the first business establishment and the second business establishment are independently selected from a paint manufacturer, paint distributor, paint retailer, hardware store, or an independent paint dealer.

5. The method of claim 2, wherein the third business establishment is selected from a paint manufacturer, paint distributor, paint retailer, hardware store, or an independent paint dealer.

6. The method of claim 1, wherein the paint container is collected in a bin or drop box at the first or second business establishment.

7. The method of claim 6, wherein the bin or drop box comprises information which explains that the paint container will be recycled.

8. The method of claim 1, wherein the first or second business establishment provides a coupon with a rebate for a product that is available to the consumer.

9. The method of claim 1, wherein the first or second business establishment recycles the collected paint container into a new paint container.

10. A composition for hardening paint comprising:
a) a hardening compound which hardens the paint with mixing;
b) an encapsulating layer comprising at least one polymeric material which surrounds the hardening compound and dissolves in the paint with mixing.

11. The composition of claim 10, wherein the composition is provided in a single packaging with an amount effective to harden approximately 10-25% of a gallon of the paint.

12. The composition of claim 10, wherein the polymeric material comprises polyvinyl alcohol, pullulan, starch, hydroxyalkylated starch, or a mixture thereof.

13. The composition of claim 10, wherein the encapsulating layer has a thickness, of about 0.5 to about 5 mm.

14. The composition of claim 10, wherein the polymeric material comprises from about 50% to about 100% of at least one water soluble polymer.

15. The composition of claim 10, wherein the polymeric material comprises from about 0% to about 50% of a solvent.

16. The composition of claim 10, wherein the encapsulating layer inhibits moisture from contacting the hardening compound.

17. A method for environmentally conscious painting comprising:
a) purchasing a paint and a paint container at a first business establishment;
b) purchasing a paint hardener from the first business establishment or a second business establishment;
c) painting a surface with the paint;
d) adding the paint hardener to the paint to substantially harden the paint;
e) removing the substantially hardened paint from the paint container;
f) disposing the substantially hardened paint;
g) returning the paint container to the first business establishment, the second business establishment, or a third business establishment.

18. The method of claim 17, wherein the paint hardener is encapsulated in a dissolvable pouch.

19. The method of claim 17, wherein the first, second and third business establishments are independently selected from a paint manufacturer, paint distributor, paint retailer, hardware store, or an independent paint dealer.

20. The method of claim 17, wherein the paint container is returned into a bin or drop box at the first, second or third business establishment.
